(19) United States
(12) Patent Application Publication
(10) Pub. No.: US 2019/0082581 A1
(43) Pub. Date: Mar. 21, 2019

(54) COMBINATION YARD TOOL ASSEMBLY

(71) Applicant: David Rathan, Scarborough (CA)

(72) Inventor: David Rathan, Scarborough (CA)

(21) Appl. No.: 15/709,580

(22) Filed: Sep. 20, 2017

(51) Int. Cl. A01B 1/02; A01D 7/06; A01B 1/20

(52) U.S. Cl. CPC A01B 1/022; A01B 1/20; A01D 7/06

(57) ABSTRACT

A combination yard tool assembly for raking, receiving and moving leaves includes a blade that has a scalloped edge. The scalloped edge is used to rake leaves and receive the leaves on the blade. The blade comprises a front side, a back side, a top edge, a bottom edge, a first lateral edge and a second lateral edge. The front side is concavely arcuate from the bottom edge to the top edge. The bottom edge comprises a serrated edge that includes a plurality of alternating concave indentations and points. The indentations extend inwardly from the front edge a distance greater than 1.5 inches. A plurality of ridges is attached to the front side and extends outwardly therefrom. A handle is attached to the blade and extends upwardly therefrom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed Under 37 CFR 1.97 and 1.98

The disclosure and prior art relates to lawn care devices and more particularly pertains to a new lawn care device for raking, receiving and moving leaves.

### BRIEF SUMMARY OF THE INVENTION

An embodiment of the disclosure meets the needs presented above by generally comprising a blade that has a scalloped edge. The scalloped edge is configured to be used to rake leaves and receive the leaves on the blade. The blade comprises a front side, a back side, a top edge, a bottom edge, a first lateral edge and a second lateral edge. The front side is concavely arcuate from the bottom edge to the top edge. The bottom edge comprises a serrated edge that includes a plurality of alternating concave indentations and points. The indentations extend inwardly from the front edge a distance greater than 1.5 inches. A plurality of ridges is attached to the front side and extends outwardly therefrom. A handle is attached to the blade and extends upwardly therefrom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front side view of a combination yard tool assembly according to an embodiment of the disclosure.

FIG. 2 is a back view of an embodiment of the disclosure.

FIG. 3 is a side view of an embodiment of the disclosure.

FIG. 4 is a front view of an embodiment of the disclosure.

FIG. 5 is a bottom view of an embodiment of the disclosure.

### DETAILED DESCRIPTION OF THE INVENTION

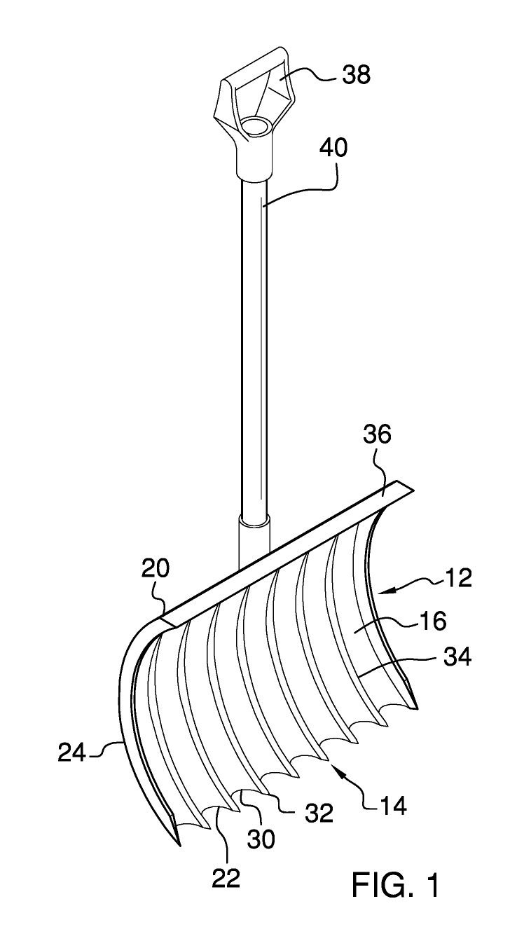

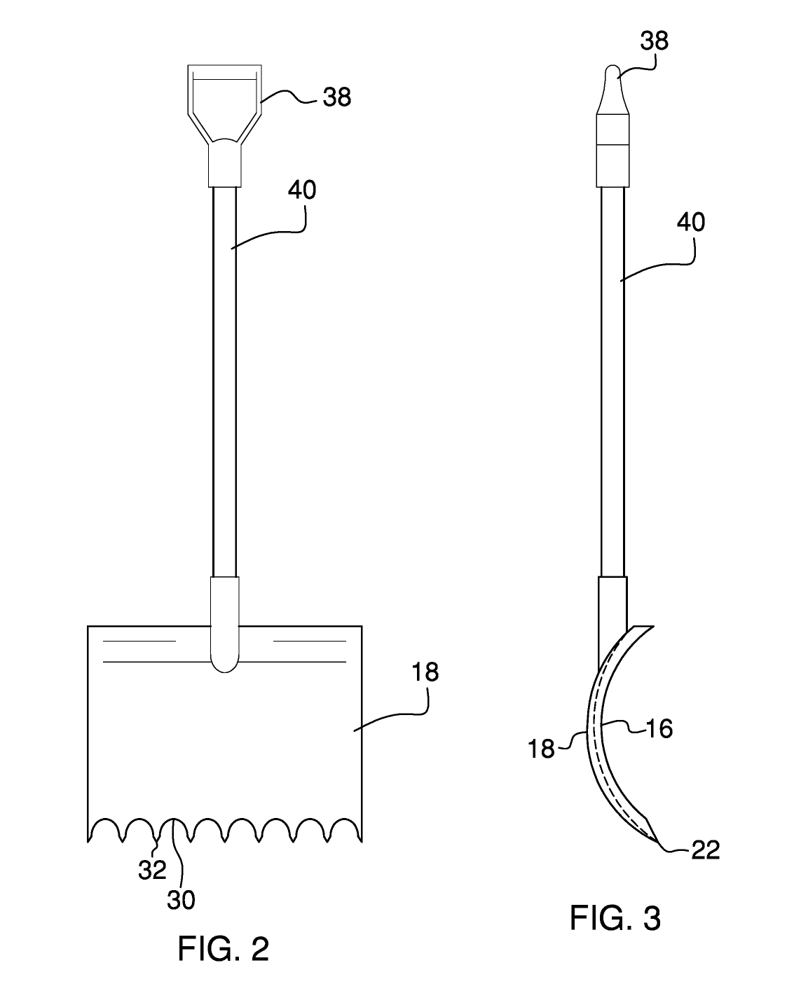

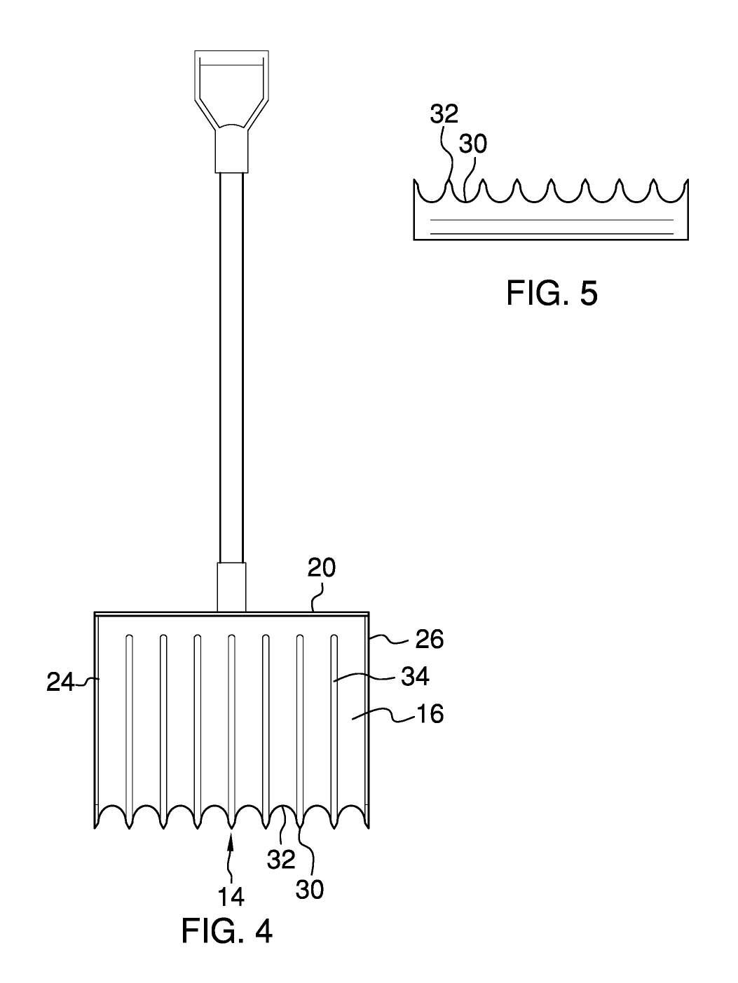

With reference now to the drawings, and in particular to FIGS. 1 through 5 thereof, a new lawn care device embodying the principles and concepts of an embodiment of the disclosure and generally designated by the reference numeral 10 will be described.

As best illustrated in FIGS. 1 through 5, the combination yard tool assembly 10 generally comprises a blade 12 that has a scalloped edge 14. The scalloped edge 14 is utilized to rake leaves and receive the leaves on the blade 12. The blade 12 comprises a front side 16, a back side 18, a top edge 20, a bottom edge 22, a first lateral edge 24 and a second lateral edge 26. The front side 16 is concavely arcuate from the bottom edge 22 to the top edge 20. The bottom edge 22 comprises a serrated edge 28 that includes a plurality of alternating concave indentations 30 and points 32. The indentations 30 extend inwardly from the front side 16 a distance greater than 1.5 inches. The blade 12 has a height from the bottom edge 22 to the top edge 20 between 7.0 inches and 12.0 inches. The blade 12 has a width from the first lateral edge 24 to the second lateral edge 26 between 9.0 inches and 20.0 inches.

A plurality of ridges 34 is attached to the front side 16 and extends outwardly therefrom. Each of the ridges 34 is orientated parallel to each other and is orientated perpendicular to the top edge 20. Each of the ridges 34 is adjoined to and extends from one of the points 32 and toward the top edge 20. Each of the ridges 34 has its greatest height in a central area of the front side 16 and decreasing in height as the ridges 34 extend in opposite directions from the central area and toward each of top edge 20 and the points 32. Each of the ridges 34 is spaced apart from each other a distance of between 1.0 inches and 4.0 inches.

A peripheral wall 36 is attached to and is coextensive with the top edge 20, the first lateral edge 24 and the second lateral edge 26. The peripheral wall 36 extends forward from the front side 16.

A handle 38 is attached to the blade 12 and extends upwardly therefrom. The handle 38 includes a shaft 40 that has a first end attached to the blade 12 adjacent to the top edge 20 and a grip that is attached to the shaft 40 distal to the blade 12. The shaft 40 may comprise of a rigid material such as wood or metal, but may be any rigid material.

In use, the handle 38 is used conventionally to direct the blade 12. The user positions the blade 12 over a ground surface with the points 32 directed towards the ground surface. The user then engages the points 32 with the ground surface and drags the points 32 along the ground surface gathering any leaves thereon. The user can use the bottom edge 22 to use the assembly as a shovel to gather the leaves onto the front side 16. Once positioned on the front side 16 a user my dispose of the leaves into a trash bag or other means of removing the leaves from the lawn.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combination shovel and rake assembly configured to be used to shovel and rake leaves, said assembly comprising:
a blade having a scalloped edge, said scalloped edge being configured to be used to rake leaves and receive the leaves on said blade, said blade comprising:
a front side, a back side, a top edge, a bottom edge, a first lateral edge and a second lateral edge, said front side being concavely arcuate from said bottom edge to said top edge, said bottom edge comprising a serrated edge including a plurality of alternating concave indentations and points, said indentations extending inwardly from said front edge a distance greater than 1.5 inches;
a plurality of ridges being attached to said front side and extending outwardly therefrom;
a handle being attached to said blade and extending upwardly therefrom.

2. The combination shovel and rake assembly according to claim 1, wherein said blade has a height from said bottom edge to said top edge being between 7.0 inches and 12.0 inches, said blade having a width from said first lateral edge to said second lateral edge being between 9.0 inches and 20.0 inches.

3. The combination shovel and rake assembly according to claim 1, wherein each of said ridges adjoins and extends from one of said points and toward said top edge.

4. The combination shovel and rake assembly according to claim 3, wherein said ridges each have a greatest height in a central area of said front side and decreasing in height as said ridges extend in opposite directions from said central area and toward each of top edge and said points.

5. The combination shovel and rake assembly according to claim 3, wherein said ridges are spaced apart from each other a distance of between 1.0 inches and 4.0 inches.

6. The combination shovel and rake assembly according to claim 1, further including a peripheral wall being attached to and being coextensive with said top edge, said first lateral edge and said second lateral edge, said peripheral wall extending forward of said front side.

7. The combination shovel and rake assembly according to claim 1, wherein said handle includes a shaft having a first end attached to said blade adjacent to said top edge and a grip being attached to said shaft distal to said blade.

8. A combination shovel and rake assembly configured to be used to shovel and rake leaves, said assembly comprising:
a blade having a scalloped edge, said scalloped edge being configured to be used to rake leaves and receive the leaves on said blade, said blade comprising:
a front side, a back side, a top edge, a bottom edge, a first lateral edge and a second lateral edge, said front side being concavely arcuate from said bottom edge to said top edge, said bottom edge comprising a serrated edge including a plurality of alternating concave indentations and points, said indentations extending inwardly from said front edge a distance greater than 1.5 inches, said blade having a height from said bottom edge to said top edge being between 7.0 inches and 12.0 inches, said blade having a width from said first lateral edge to said second lateral edge being between 9.0 inches and 20.0 inches;
a plurality of ridges being attached to said front side and extending outwardly therefrom, each of said ridges being orientated parallel to each other and being orientated perpendicular to said top edge, each of said ridges adjoining and extending from one of said points and toward said top edge, said ridges having a greatest height in a central area of said front side and decreasing in height as said ridges extend in opposite directions from said central area and toward each of top edge and said points, said ridges being spaced apart from each other a distance of between 1.0 inches and 4.0 inches;
a peripheral wall being attached to and being coextensive with said top edge, said first lateral edge and said second lateral edge, said peripheral wall extending forward of said front side;
a handle being attached to said blade and extending upwardly therefrom, said handle including a shaft having a first end attached to said blade adjacent to said top edge and a grip being attached to said shaft distal to said blade.
